(19) United States
(12) Patent Application Publication
(10) Pub. No.: US 2026/0181120 A1
(43) Pub. Date: Jun. 25, 2026

(54) VOLUMETRIC SENSING USING A CONTAINER MONITORING SYSTEM

(71) Applicant: SmartWitness USA, LLC, Schaumburg, IL (US)

(72) Inventor: Brian Joseph Walstrom, Attleboro, MA (US)

(21) Appl. No.: 19/541,926

(22) Filed: Feb. 17, 2026

Related U.S. Application Data
(63) Continuation of application No. PCT/US2023/030520, filed on Aug. 17, 2023.

(51) Int. Cl. H04N 13/239; G06Q 10/08; G06T 7/70; G06T 7/80; G06V 20/10

(52) U.S. Cl. CPC H04N 13/239; G06Q 10/08; G06T 7/70; G06T 7/85; G06V 20/10

(57) ABSTRACT

Methods, apparatuses, system, devices, and computer program products for volumetric sensing using a container monitoring system are disclosed. In a particular embodiment, a cargo monitoring system captures a first set of images of a dock scene through the stereo vision system of the dock-mounted monitoring device. The cargo monitoring system calibrates the stereo vision system of the dock-mounted monitoring device based on the first set of images. The container monitoring system determines, based on the first set of images, localization parameters for the dock-mounted monitoring device with respect to a container in the dock scene. The container monitoring system generates a disparity map for the dock scene based on the first set of images. The container monitoring system generates a depth map of an interior space of the container based on the disparity map and the localization parameters.

### CROSS-REFERENCE TO RELATED APPLICATION

This application is a continuation of and claims the benefit of and priority to international Application No. PCT/US2023/030520, filed on Aug. 17, 2023, all the content of which is hereby incorporated by reference in their entirety.

### BACKGROUND

Cargo shipping and transportation is one of the major lifelines for society and facilitates efficiently moving goods across long distances. For example, companies can fill cargo containers with products for transport using tractors, trains, ships, etc. To minimize the high cost of such transportation, cargo containers should be packed as efficiently as possible. However, it may be difficult for dock personnel to accurately determine the remaining capacity in a cargo container when loading the container. Similarly, it may be difficult to identify when cargo items have been inefficiently placed in the container, thus reducing the amount of cargo that the container will hold.

Light detection and ranging (LiDAR) can be used to obtain depth measurements for volumetric sensing to estimate the occupancy of cargo in a container. However, LiDAR systems are very expensive and difficult to maintain calibration. Active light loses depth accuracy in the presence of ambient light; thus, dock lights can degrade system performance. Further, cargo sensors for trailers require long range depth measurements. A standard trailer is 53 feet and the device may be mounted back from the door requiring a depth measurement of 60 feet or more. A long-range LiDAR system has safety considerations because it can require a significant laser for an active light source, which could potentially cause eye damage to nearby personnel.

### SUMMARY

Methods, apparatuses, system, devices, and computer program products for volumetric sensing using a container monitoring system are disclosed. In a particular embodiment, a dock sensing controller uses images captured by a dock-mounted monitoring device for volumetric sensing of a cargo container. The dock-mounted monitoring device includes a depth camera implemented by a stereo vision system including two monocular cameras. The stereo vision system is safer and lower in cost compared to a LiDAR system. Further, the stereo vision system is self-calibrating. The dock sensing controller is self-localizing, such that the orientation of the dock-mounted monitoring device with respect to a docked container is continuously determined through machine vision and feature extraction. In some examples, a trained object detector is used to distinguish between a full container and a container with a closed door. In some implementations, the dock sensing controller further uses the object detector to classify a container as empty. When the container is empty, the dock sensing controller generates a depth map of the container from volumetric sensing data. As cargo is loaded into the container, the dock sensing controller generates a cargo map and reports the occupancy of the container (i.e., how full the container is). An infrared sensor may be used to identify periods of loading or unloading. The dock sensing controller may further detect and report loading inefficiencies such as gaps between pallets, crates, or other cargo items.

In a particular embodiment, a dock sensing controller utilizes a first set of images of a dock scene captured from a stereo vision system of a container monitoring system. The dock sensing controller determines, based on the first set of images, localization parameters for a dock-mounted monitoring device with respect to a container in the dock scene. The dock sensing controller generates a depth map of an interior space of the container based on the localization parameters and the first set of images. When the dock sensing controller captures an updated set of images, the dock sensing controller may identify a change in the dock scene relating to the interior space of the container, where the change in the dock scene indicates the presence of cargo. The dock sensing controller generates, based on the depth map and a cargo estimation from a second set of images, a cargo map of the container.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth diagram illustrating a dock scene suitable for a container monitoring system for volumetric sensing using a container monitoring system in accordance with at least one embodiment of the present disclosure;

FIG. 2 sets forth a block diagram illustrating a container monitoring system for volumetric sensing using a container monitoring system in accordance with at least one embodiment of the present disclosure;

FIG. 3 is a flowchart to illustrate an implementation of a method for volumetric sensing using a container monitoring system in accordance with at least one embodiment of the present disclosure;

FIG. 4 is a flowchart to illustrate another implementation of a method for volumetric sensing using a container monitoring system in accordance with at least one embodiment of the present disclosure;

FIG. 5 is a flowchart to illustrate another implementation of a method for volumetric sensing using a container monitoring system in accordance with at least one embodiment of the present disclosure.

FIG. 6 is a flowchart to illustrate another implementation of a method for volumetric sensing using a container monitoring system in accordance with at least one embodiment of the present disclosure.

FIG. 7 is a flowchart to illustrate another implementation of a method for volumetric sensing using a container monitoring system in accordance with at least one embodiment of the present disclosure.

FIG. 8 is a flowchart to illustrate another implementation of a method for volumetric sensing using a container monitoring system in accordance with at least one embodiment of the present disclosure.

FIG. 9 is a flowchart to illustrate another implementation of a method for volumetric sensing using a container monitoring system in accordance with at least one embodiment of the present disclosure.

FIG. 10A illustrates an example overhead cargo map for volumetric sensing using a container monitoring system in accordance with at least one embodiment of the present disclosure.

FIG. 10B illustrates an example perspective cargo map for volumetric sensing using a container monitoring system in accordance with at least one embodiment of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Aspects of the present disclosure include an Internet of Things (IoT) cargo monitoring device mounted at a freight loading dock to monitor cargo in a trailer or other container. In accordance with certain aspects, the device may include a depth camera, such as a stereo camera system, with a view of the interior of a docked trailer. The image sensors, lenses and stereo geometry of the depth camera may be designed for a dock-mounted system. The device may be connected to wired power and may utilize a cellular network, Wi-Fi network, or Ethernet for connectivity. The device may be configured to read data from labels on cargo, such as a bar code, data matrix, quick response (QR), or through optical character recognition.

In accordance with certain aspects, the cargo monitoring device is used to generate a freight loading map of the trailer, indicating where pallets, crates, or other cargo items are in the trailer and how much space is available for use. The cargo map may include data on cargo ‘gaps’ where a pallet or crate is not placed correctly in the trailer and there is unused space around it. The cargo monitoring device may detect and report episodes of loading or unloading, and an infrared sensor may be used to facilitate detection of periods of loading and unloading.

In accordance with certain aspects, the depth camera measures the length of the trailer parked at the dock. A machine learning algorithm using stereo camera data will continuously self-discover the location of the device relative to a parked trailer, a process referred to as ‘localization.’ A computer vision algorithm may determine whether the trailer door is open or closed. An object detector using a machine learning classifier may be used to determine if the trailer is completely empty.

An embodiment in accordance with the present disclosure is directed to a method of volumetric sensing using a container monitoring system. The method includes utilizing, by a dock sensing controller of a container monitoring system, a first set of images of a dock scene through a stereo vision system of a dock-mounted monitoring device. The method also includes determining, by the dock sensing controller based on the first set of images, localization parameters for the dock-mounted monitoring device with respect to a container in the dock scene. The method also includes generating, by the dock sensing controller based on the localization parameters and the first set of images, a depth map of an interior space of the container. The method also includes generating, by the dock sensing controller based on the depth map and a cargo estimation from a second set of images, a cargo map of the container.

In some implementations, the stereo vision system includes at least a first camera and a second camera; and wherein the disparity map includes a pixel offset for each pixel in a first image captured by the first camera relative to a second image captured by the second camera. In some implementations, the dock-mounted monitoring device is installed at a fixed position at a dock. In some implementations, the container is a trailer parked at the dock.

In a variation, the method also includes detecting, by a trained machine learning classifier of the dock sensing controller, that a door of the container is open. In another variation, the method also includes detecting, based on at least infrared sensor data, a loading event.

In another variation, the method also includes utilizing a second set of images of the dock scene. In this variation, the method also includes detecting a scene change in the interior space of the container.

In another variation, the method also includes classifying an occupancy of the container. In a variation, the method also includes detecting a loading inefficiency in the container. The loading inefficiency may be based on the distance between a first cargo item and a second cargo item. In another variation, the method also includes displaying the cargo map to a user.

Another embodiment is directed to an apparatus for volumetric sensing using a container monitoring system. The apparatus includes a processor and memory storing instructions that, when executed by the processor, cause the apparatus to carry out operation utilizing, by a dock sensing controller of a container monitoring system, a first set of images of a dock scene through a stereo vision system of a dock-mounted monitoring device. The instructions further cause the apparatus to carry out the operation of determining, by the dock sensing controller based on the first set of images, localization parameters for the dock-mounted monitoring device with respect to a container in the dock scene. The instructions further cause the apparatus to carry out the operation of generating, by the dock sensing controller based on the localization parameters and the first set of images, a depth map of an interior space of the container. The instructions further cause the apparatus to carry out the operation of generating, by the dock sensing controller based on the depth map and a cargo estimation from a second set of images, a cargo map of the container.

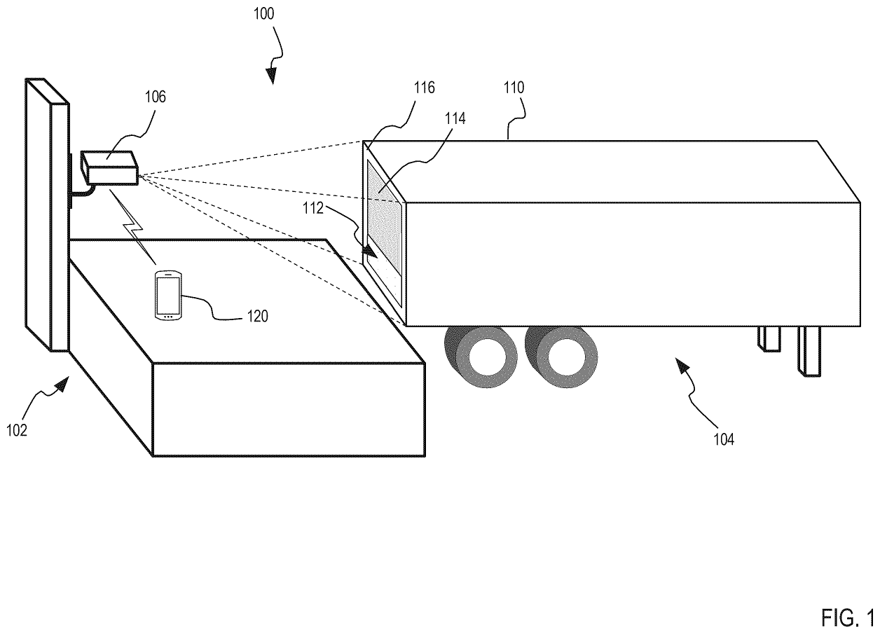

Exemplary methods, apparatuses, and computer program products for volumetric sensing using a container monitoring system in accordance with the present invention are described with reference to the accompanying drawings, beginning with FIG. 1. FIG. 1 illustrates a dock scene 100 in which volumetric sensing using a container monitoring system may be implemented. The dock scene 100 includes a dock 102 and a container 104 located at the dock. For example, the container 104 may be a trailer or a freight container. A dock-mounted monitoring device 106 of a container monitoring system is mounted at a fixed location at the dock 102. The dock-mounted monitoring device 106 is configured to capture images of the dock scene 100 through a stereo vision system. While the location of the dock-mounted monitoring device 106 is known with respect to the dock 102, the location and size of the container is variable. For example, the location at which a trailer is parked at the dock may vary. While the general location of a trailer can be expected, the exact location depends on where the driver has parked the trailer. Even when there is a dock door, the exact location of the container within a doorway may vary. Thus, a dock-mounted monitoring device 106 in accordance with the present disclosure localizes itself with respect to a container at the dock 102. Through machine vision and machine learning, the dock-mounted monitoring device 106 continuously discovers the location of a container that is detected at the dock and the orientation of the container with respect to the dock-mounted monitoring device 106.

As shown in FIG. 1, a container 104 may include an enclosure 110 having an interior space 112 and a door 114. The end of the container 104 opposite the door 114 is referred to as the ‘nose.’ The door 114 may be a roll-up door, a hinged door, and so on. Generally, the enclosure 110 defines a frame 116 for the door 114. In some examples, the enclosure 110 is substantially rectangular, having five planar surfaces (floor, ceiling, sidewalls and nose) as well as the door 114. However, in other examples, the enclosure 110 may have a non-rectangular shape.

The dock-mounted monitoring device 106 may be part of a container monitoring system that includes a remote computing device 120. For example, the remote computing device may be a mobile device carried by dock personnel, or a desktop or laptop computer through which personnel monitor the loading or unloading of the container. In some implementations, the dock-mounted monitoring device 106 wirelessly communicates with the remote computing device 120 through a network, such as a Wi-Fi or mobile broadband network.

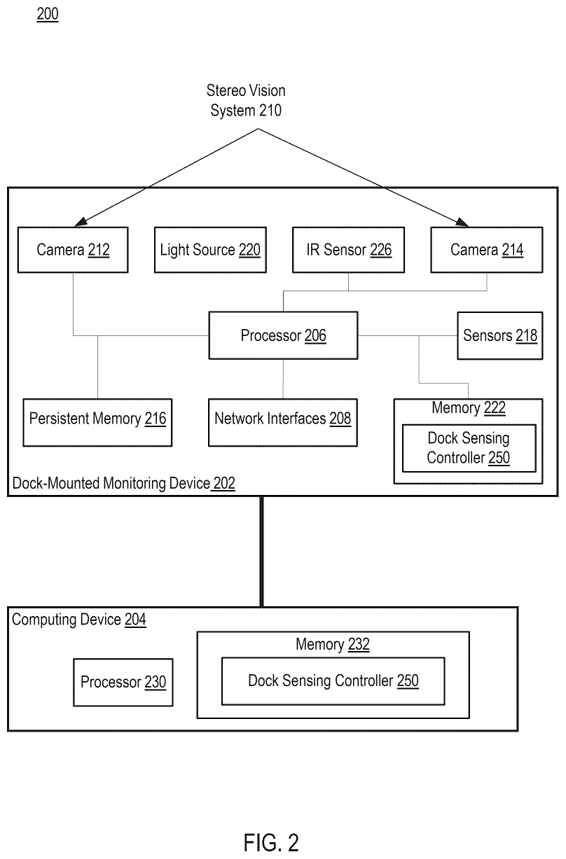

For further explanation, FIG. 2 illustrates a diagram of an example container monitoring system 200 for volumetric sensing using a container monitoring system in accordance with at least one embodiment of the present disclosure. In the example of FIG. 2, the container monitoring system 200 includes a dock-mounted monitoring device 202 and a computing device 204. The computing device 204 may be a desktop computer, a server, a laptop computer, a mobile device such as a smartphone or tablet, or a cloud-based computing system. The computing device 204 is configured to receive data transmitted by the dock-mounted monitoring device 202. In some examples, the computing device 204 receives volumetric sensing data (e.g., a cargo map) from the dock-mounted monitoring device 202 and causes the data to be displayed to a user. In other examples, the computing device 204 is configured to receive raw data (e.g., image data) and generate volumetric sensing data (e.g., a cargo map) for display to a user. In still other examples, the processing of image data to generate volumetric sensing data is carried out in part at the dock-mounted monitoring device 202 and in part at the computing device 204.

In some implementations, the dock-mounted monitoring device 202 includes a processor 206 coupled to a memory 222. The processor 206 may include or implement a central processing unit (CPU) or other general-purpose processor, a graphics processing unit (GPU), a field programmable gate array (FPGA), an application specific integrated circuit (ASIC), a digital signal processor (DSP), a microcontroller, or similar computational device. The dock-mounted monitoring device 202 further includes one or more network interfaces 208 that facilitate communication, either wired or wireless, between the dock-mounted monitoring device 202 and the computing device 204. The one or more network interfaces 208 can support a variety of communications protocols including Ethernet, mobile broadband protocols (e.g., 4G, 5G, etc.), Wi-Fi, Bluetooth, and so on. The dock-mounted monitoring device 202 further includes a stereo vision system 210 (e.g., a depth camera), described in more detail below. The dock-mounted monitoring device 202 further includes a persistent memory 216 (e.g., solid state memory or a hard drive) that can store, for example, frames of image data (e.g., reference frames) as well as calibration data and other configuration data. In some implementations, the dock-mounted monitoring device 202 further includes an infrared sensor 226 such as a passive infrared sensor. The dock-mounted monitoring device 202 may include one or more other sensors 218 such as time-of-flight sensors (e.g., ultrasonic sensors), ambient light sensors, and so on. In some implementations, the dock-mounted monitoring device 202 includes a light source 220 such as an LED for illuminating the interior of a container.

In some implementations, the memory 222 stores a dock sensing controller embodied in one or more modules of computer programing instructions that, when executed by the processor 206, cause the dock-mounted monitoring device 202 to carry out the steps of: utilizing a first set of images of a dock scene through a stereo vision system of a dock-mounted monitoring device; calibrating, based on the first set of images, the stereo vision system of the dock-mounted monitoring device; determining, based on the first set of images, localization parameters for the dock-mounted monitoring device with respect to a container in the dock scene; generating, based on the first set of images, a disparity map for the dock scene; and generating, based on the localization parameters and the disparity map, a depth map of an interior space of the container.

In some implementations, the computing device 204 includes a processor 230 and a memory 232 storing a dock sensing controller embodied in one or more modules of computer programming instructions that, when executed by the processor 230, cause the computing device 204 to carry out the steps of: utilizing a first set of images of a dock scene captured through a stereo vision system of a dock-mounted monitoring device; calibrating, based on the first set of images, the stereo vision system of the dock-mounted monitoring device; determining, based on the first set of images, localization parameters for the dock-mounted monitoring device with respect to a container in the dock scene; generating, based on the first set of images, a disparity map for the dock scene; and generating, based on the localization parameters and the disparity map, a depth map of an interior space of the container.

In some implementations, the stereo vision system 210 includes at least two standard two-dimensional cameras 212, 214 that have overlapping fields of view. These two-dimensional (2-D) cameras may each include a digital image sensor such as a complementary metal oxide semiconductor (CMOS) image sensor or a charge coupled device (CCD) image sensor and an optical system (e.g., one or more lenses) configured to focus light onto the image sensor. The optical axes of the optical systems of the 2-D cameras may be substantially parallel such that the two cameras image substantially the same scene, albeit from slightly different perspectives. Accordingly, due to parallax, portions of a scene that are farther from the cameras will appear in substantially the same place in the images captured by the two cameras, whereas portions of a scene that are closer to the cameras will appear in different positions. The cameras 212, 214 may be rigidly attached, e.g., in a housing of the dock-mounted monitoring device 202, such that their relative positions and orientations are substantially fixed. Using geometrically calibrated 2-D cameras, it is possible to identify the 3-D locations of all visible points in a scene with respect to a reference coordinate system (e.g., a coordinate system having its origin at the stereo vision system). Thus, a depth image captured by the stereo vision system can be represented as a 3-D point cloud, which can be used to describe surfaces within the field of view of the stereo vision system.

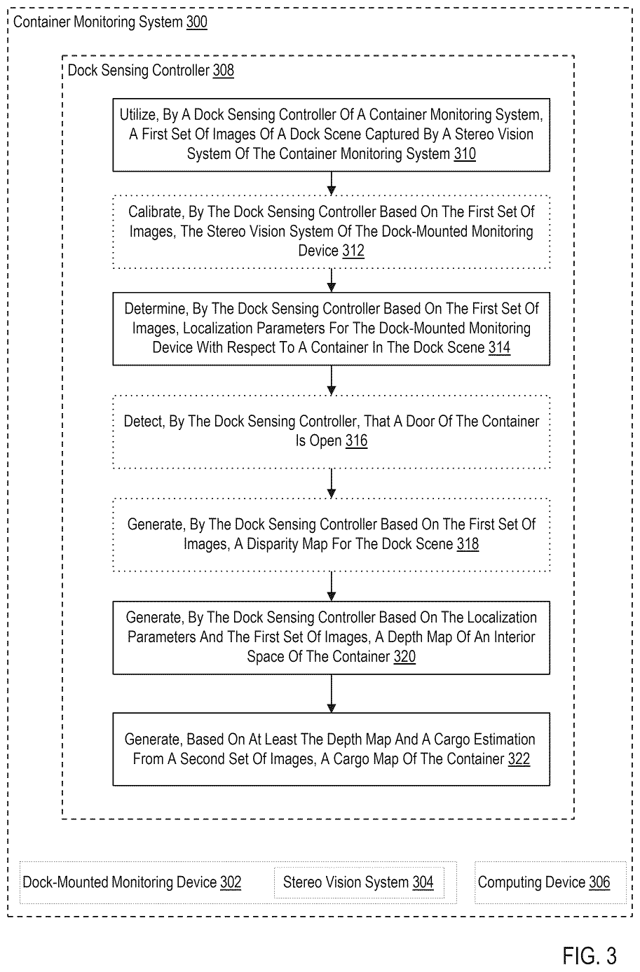

For further explanation, FIG. 3 sets forth a flow chart illustrating an example method of volumetric sensing using a container monitoring system in accordance with at least one embodiment of the present disclosure. The example of FIG. 3 includes a container monitoring system 300, which may be configured similarly or the same as the container monitoring system 200 of FIG. 2. The container monitoring system 300 includes a dock-mounted monitoring device 302 (e.g., the dock-mounted monitoring device 106 of FIG. 1 or the dock-mounted monitoring device 202 of FIG. 2). The dock-mounted monitoring device 302 includes a stereo vision system 304, such as the stereo vision systems discussed above. The container monitoring system 300 also includes a computing device 306, which may be configured similarly or the same as the computing device 204 of FIG. 2. The container monitoring system 300 further includes a dock sensing controller 308 (e.g., the dock sensing controller 250 of FIG. 2), aspects of which are explained in detail below. In some implementations, the dock sensing controller 308 is implemented by the dock-mounted monitoring device 302 (e.g., the dock-mounted monitoring device 106 of FIG. 1 and the dock-mounted monitoring device 204 of FIG. 2). In other implementations, the dock sensing controller 308 is implemented by the computing device 306 (e.g., the computing device 120 of FIG. 1 and the computing device 204 of FIG. 2). In still further implementations, some aspects of the dock sensing controller 308 are implemented by the dock-mounted monitoring device 302 while other aspects are implemented by the computing device 306. Thus, the dock sensing controller 308 may be executed by the dock-mounted monitoring device 302, a computing device 306 such as a tablet or smart phone, or any other computing device in the container monitoring system 300.

The method of FIG. 3 includes utilizing 310, by a dock sensing controller 308 of a container monitoring system 300, a first set of images of a dock scene captured by a stereo vision system 304 of the container monitoring system 300. In some implementations, the dock sensing controller 308 utilizes 310 the set of images by storing a set of images to be used in generating a visual mapping of the cargo space of a container, which is useful in determining and monitoring the volume of the cargo in the container. Where aspects of volumetric sensing of the dock sensing controller 308 are implemented in the dock-mounted monitoring device 302, utilizing 310 the first set of images can include capturing the images and storing the images to be used for volumetric sensing. Where aspects of volumetric sensing of the dock sensing controller 308 are implemented in the computing device 306, utilizing 310 the first set of images can include receiving the images from the dock-mounted monitoring device 302 and storing the images to be used for volumetric sensing. In some examples, the stereo vision system 304 of the dock-mounted monitoring device 302 captures a set of images of the dock scene that includes a container such as a trailer parked at a dock.

In some implementations, the method of FIG. 3 can also include calibrating 312, by the dock sensing controller 308, the stereo vision system 304. In some examples, the dock sensing controller 308 calibrates 312 the stereo vision system 304 by self-calibrating the set of cameras of the stereo vision system 304. The purpose of stereo calibration is to find intrinsic camera parameters (e.g., focal length, optical axis, distortion, etc.) and extrinsic parameters (e.g., the translation and rotation transform between the perspectives used for image captures). In some examples, cameras 1 and 2 and any associated lenses used alongside cameras 1 and 2 are known, so the intrinsic camera parameters are known. Furthermore, the optical axis can be assumed to be located in the middle of a captured image. The translation between camera 1 and 2 is also assumed as a known quantity in some implementations. The translation is determined by geometry of the dock-mounted monitoring device 302 and location of the two cameras relative to each other in the housing of the dock-mounted monitoring device 302. Minor flexing in a printed circuit board (PCB) in the dock-mounted monitoring device 302 or flexing of the housing of the dock-mounted monitoring device 302 can cause small angle variations between cameras 1 and 2. Traditional ‘uncalibrated’ stereo systems usually use image data to calibrate all unknown parameters at once. The dock-mounted monitoring device 302 of the present disclosure separately calibrates the pitch, yaw, and roll angles and measures these angles at different times, maintaining each angle independently. For example, yaw angle is continuously calibrated from only field data (i.e., images of the dock area). The stereo pitch and roll are also continuously calibrated from field data.

The method of FIG. 3 also includes determining 314, by the dock sensing controller 308, localization parameters for the dock-mounted monitoring device 302 with respect to a container. The dock-mounted monitoring device 302 is installed at a fixed position at a dock and installation angles are taken into account when generating localization parameters. However, as discussed above, the exact location of a container in a dock scene may vary. The dock sensing controller 308 determines 314 localization parameters that describe the orientation of the dock-mounted monitoring device 302 with respect to the container.

In some implementations, the dock sensing controller 308 detects the presence of a container in the dock scene by, for example, comparing the set of images to a reference image. The reference image may be an image captured when no containers are present in the dock scene, or simply a previously captured image. In some implementations, the dock sensing controller 308 includes an object detector, such as a machine learning classifier, which is trained to detect the presence of a container at the dock. The object detector may be trained using images of various containers at the dock as training data. In some implementations, the dock sensing controller 308 utilizes a feature extraction algorithm to determine the edges of the periphery of the container, such as the frame of the container door; alternative, the dock sensing controller 308 utilizes a feature extraction algorithm to determine the location of the door. Once the container is located through feature extraction or other machine vision algorithms, the dock sensing controller 308 determines 314 localization parameters by determining the yaw, pitch, and roll angles of the dock-mounted monitoring device 302 with respect to the container. That is, the localization parameters describe the location of the container within the reference coordinate system of the dock-mounted monitoring device 302.

In some implementations, the method of FIG. 3 can also include detecting 316, by dock sensing controller 308, that a door of the container is open. Using traditional machine vision techniques, it may be difficult for a machine vision algorithm to distinguish between a full container and a closed door. In some implementations, the dock sensing controller 308 includes an object detector, such as a machine learning classifier, which is trained to detect whether a container door is open or closed. The object detector may be a convolutional neural network (CNN) or deep CNN classifier that takes, as an input, an image of a container and outputs a determination that the container door is open or closed. The object detector may be trained using images of full containers with the door open, empty containers with the door open, and containers with the door closed as training data. The object detector for detecting whether a door is open or closed may be incorporated into any of the object detectors discussed above, or may be a separate model.

In some implementations, the method of FIG. 3 can also include generating 318, by the dock sensing controller 308, a disparity map for the dock scene. In some examples, the dock sensing controller 308 generates 316 a disparity map based at least in part on a relationship between sensors in the stereo vision sensor that produced the set of images. In an example, consider two cameras in use: camera 1 and camera 2. For example, assume camera 1 is the origin perspective and produces multiple camera 1 images, then the dock scene is shifted in multiple camera 2 images produced by camera 2 because there is a non-zero position (e.g., translation and/or rotation) offset for camera 2 relative to the camera 1 origin. In some implementations, the disparity map is a matrix that is the same size as each image in the set of images. The disparity map holds the pixel offset for each pixel in an image from camera 1 to the matched pixel in images from camera 2. Objects that are close to cameras 1 and 2 will have large disparity values (i.e., large pixel shifts) and objects far away will have smaller disparity values (i.e., small pixel shifts). Disparity mapping helps take perspective into consideration. Given a first sample image from camera 1 and a second sample image from camera 2, the disparity map between these two images will describe a shift or transformation that should be performed to obtain the first image from the second image. Since closer objects will exhibit larger shifts compared to farther objects, the dock sensing controller 308 divides the two images into regions of interest based on object depth within the image. Given that the cameras that obtained the first and second images will provide images with a perspective, and given that these cameras are mounted at a dock, the nose of the trailer can be used as the farthest location within the trailer and can be used as the spot with the lowest angular shift between the first image and the second image.

In some implementations, to build the disparity map, the dock sensing controller 308 enhances image contrast of the representative images. Pixel matching between an image from camera 1 and an image from camera 2 of the same scene is performed. Camera 1 and camera 2 have different perspectives of the scene. Matching algorithms exploit features in the images, such as edges, and corners. During image contrast enhancement, a sharpening filter can be used to enhance edges and corners, and a smoothing filter can be used to reduce noise from the sharpening filter. Image processing techniques including blurring techniques, determining integral images, image blending techniques, etc., can be used in the sharpening and/or smoothing filters. In some implementations, OpenCV image library is used to implement the blurring and blending and obtaining the integral images.

In some implementations, to build the disparity map, the dock sensing controller 308 first aligns a first enhanced image from camera 1 and a second enhanced image from camera 2 based on the pitch, yaw, and roll angles obtained during stereo calibration. Because of small pitch and roll angles between the cameras, a given row of pixels in the first enhanced image from camera 1 does not line up with the same row of pixels in the second enhanced image from camera 2. The second enhanced image undergoes a perspective transformation to adjust for these angles. In some implementations, the dock sensing controller filters static environment from the aligned image.

The method of FIG. 3 also includes generating 320, by the dock sensing controller 308 based on the localization parameters and the first set of images, a depth map of an interior space of the container. Given a particular orientation based on the localization parameters, the dock sensing controller 308 generates the depth map using a feature extraction algorithm to identify edges in the image where the walls, floor, and ceiling of the container meet. That is, for a given orientation of the trailer, the five visible planes of the interior of the trailer are determined based on the position of the container relative to the dock-mounted monitoring device 302. The lines of intersection of the planes can be projected back into image coordinates providing a set of pixels where edges are expected to be found in the scene. This allows for a search of orientation space for the best fit between candidate edge locations and actual edges in the image. In some implementations, cross-correlation based corner searches for empty trailers use the localization parameters to narrowly search a small region of captured images; the small region includes at least a portion where the corner of the trailer is expected to reside. When the container is detected to be empty, the container depth from the disparity map and orientation from the localization parameters are determined and used as an ideal depth map for future processing of the images captured while the container is at dock.

The ideal depth is a depth map of an empty trailer. In some implementations, the empty trailer is rendered, based on the localization parameters. The ideal depth is determined as a baseline comparison. The yaw angle between the cameras causes a fixed offset in the disparity map. The yaw angle can be determined by converting the depth reference into a disparity reference and subtracting it from the measured disparity map. The mode in the difference map can provide the yaw angle, with the mode being found using kernel density estimation. The mode is used because the yaw will have a constant offset on the disparity map. If the yaw does not present about a constant offset, then this indicates less confidence in the yaw value.

In some implementations, detecting whether the container is empty is carried out by detecting cargo in the container. The presence of cargo may be detected using saturation characteristics of the container scene, corner matching, and so on. The shape of the cargo can be assumed to be a rectangular prism; thus, cargo estimation involves determining the height, width, and length of the prism. In some implementations, a trained object detector is used to detect the presence of cargo. The object detector may be a CNN that is trained, for example, on images of cargo within a container. For example, the object detector may be trained to identify pallets of cargo. The object detector for detecting an empty trailer may be incorporated into any of the object detectors discussed above, or it may be a separate model.

In some implementations, a cross-correlation algorithm is used to determine whether the container is empty. One factor that can impact reporting accuracy of the dock sensing controller 308 is an empty container. From a small sample image, determining whether the container is empty is trivial to a human, but in computer vision, it is advantageous that the dock sensing controller 308 does not over report (e.g., indicating an occupancy of 10% or 20% when the container is empty). Unfortunately, depth accuracy for stereo systems is worse at longer distances. An empty container presents the longest distances measured by the dock sensing controller 308 because the dock sensing controller 308 is measuring distance to the walls everywhere in the image. In order to increase accuracy when the container is empty, the dock sensing controller 308 can include an additional algorithm for classification when the container is empty. In some implementations, the dock sensing controller 308 uses a set of ‘templates’ of the back corners of the container. A cross-correlation search compares the expected location of the back corners of the container against the known set of templates. If a good match is found, then the dock sensing controller 308 determines that the back corners of the container are in view. If the corners are in view the dock sensing controller 308 labels the scene as empty, and the dock sensing controller 308 reports that the container is empty. In some implementations, the dock sensing controller 308 determines that the container is empty whenever the back corners of the container are in view. This assumption can reduce computation and can apply in most situations. Containers are typically loaded from the back and loads are moved forward in order to maximize space and to secure loads. It is very unlikely a single pallet is left in the middle of a container for shipment.

The method of FIG. 3 further includes generating 322, based on at least the depth map and a cargo estimation from a second set of images, a cargo map of the container. In some examples, the dock sensing controller detects the presence of cargo in the container from a second set of images captured sometime after the first set of images; that is, the second set of images is captured after cargo loading begins. For example, if a change in the dock scene indicates a change in the interior space of the container, a cargo search is performed. In some examples, a trained object detector is used to identify cargo in the container. For example, the trained object detector may include a deep convolutional neural network that is trained to detect and classify cargo. In some examples, edge detection and corner matching are used to identify cargo. Cargo estimation may involve determining a shape of the cargo starting from the nose of the trailer. The shape of the cargo can be assumed to be a rectangular prism; thus, cargo estimation involves determining the height, width, and length of the prism. In some implementations, the dock sensing controller 308 generates cargo map parameters that can include cargo depth, cargo depth fitness, and cargo floor. Cargo depth fitness may be a confidence score associated with the cargo depth. The cargo map parameters are applied to the depth map to generate the cargo map. In some examples, cargo estimation uses the depth map, rendered from the localization parameters, to fit a cargo estimate to the disparity map.

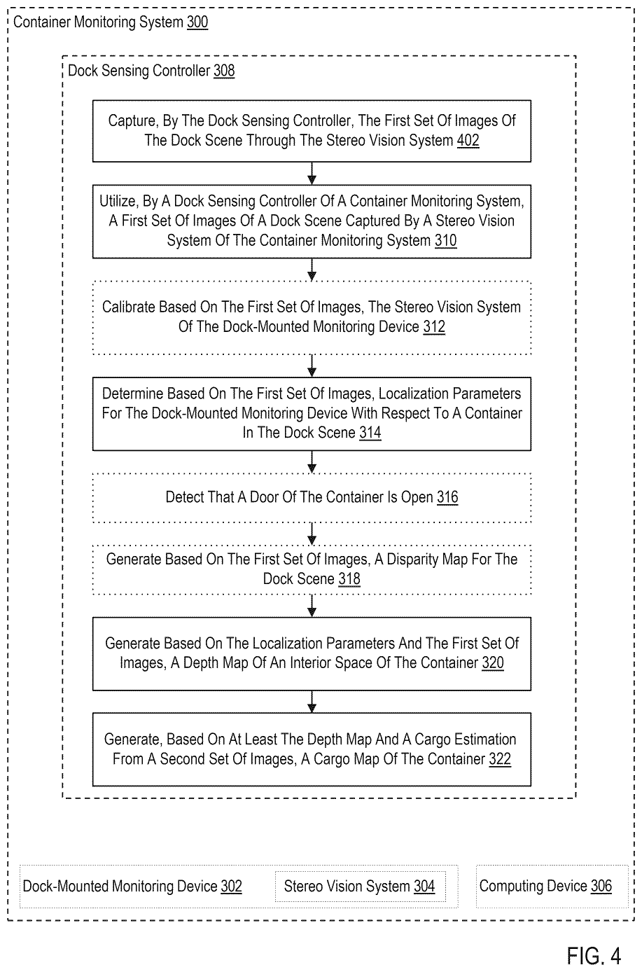

For further explanation, FIG. 4 sets forth another method of volumetric sensing using a container monitoring system in accordance with at least one embodiment of the present disclosure. The method of FIG. 4 extends the method of FIG. 3 in that the method of FIG. 4 further comprises capturing 402, by the dock sensing controller 308, the first set of images of the dock scene through the stereo vision system. In some implementations, the dock sensing controller 308 causes the dock-mounted monitoring device 302 to capture one or more sets of stereo images of the dock scene through the stereo vision system 304. The stereo vision system 304 can include two or more image sensors or cameras. In some implementations, the stereo vision system 304 includes two cameras that generate the set of images. In some implementations, the set of images is generated by burst. That is, each camera can generate multiple images in a short timeframe (e.g., two images generated in one second, three images generated in one second, ten images generated in one second, twenty images generated in one second, etc.). Since the cameras are each generating multiple images of the same dock area, there is a pixel relationship between each of the multiple images in the set of images. This pixel relationship is used to reduce noise by aligning the multiple images. Thus, in some examples, the dock sensing controller 308 pre-processes the set of images to increase image quality and reduces the effect of ambient lighting in the set of images. In some implementations, the dock sensing controller 308 enhances contrast of the images representing the dock area using the set of images obtained by the stereo vision system 304. Noise reduction and contrast enhancement improves image quality, allowing to remove effect of ambient lighting condition within the cargo space for producing uniform images regardless of the lighting conditions.

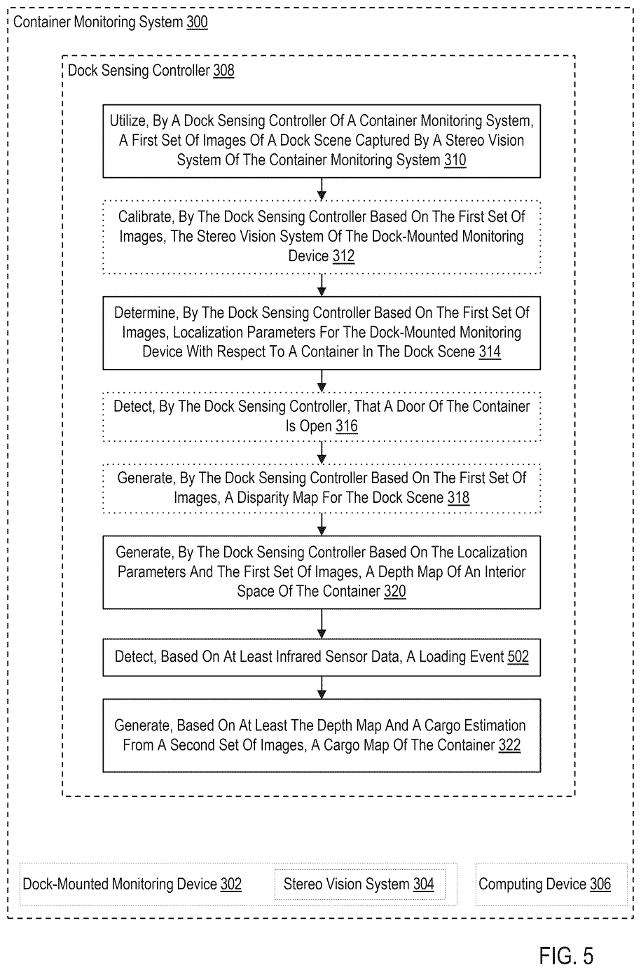

For further explanation, FIG. 5 sets forth another method of volumetric sensing using a container monitoring system in accordance with at least one embodiment of the present disclosure. The method of FIG. 5 extends the method of FIG. 3 in that the method of FIG. 5 further comprises detecting 502, based at least on infrared sensor data, a loading event. In some implementations, the updated set of images is captured based on detecting motion in the dock scene from infrared sensor data. For example, infrared sensor data may indicate that machinery (e.g., a forklift) or humans are moving cargo into (or out of) the container. Detection of the loading event may trigger the capture of images by the stereo vision system of the dock-mounted monitoring device 302. The infrared sensor data may be fused with contemporaneously captured image data to identify the loading or unloading event. In some implementations, the infrared sensor data is cross correlated with pixel data from the images to determine whether the motion detected from infrared sensor data corresponds to movement within the container. The loading event may be reported to the remote computing device. In some implementations, the dock-mounted monitoring device identifies a label on the top of a pallet, crate, or other cargo item as it is loaded into or unloaded from the container. For example, the label may include characters, a data matrix, a quick response (QR) code, a bar code, or other data indicia. The dock-mounted monitoring device extracts the data from the label and records the information in persistent storage or transmits the data to the remote computing device.

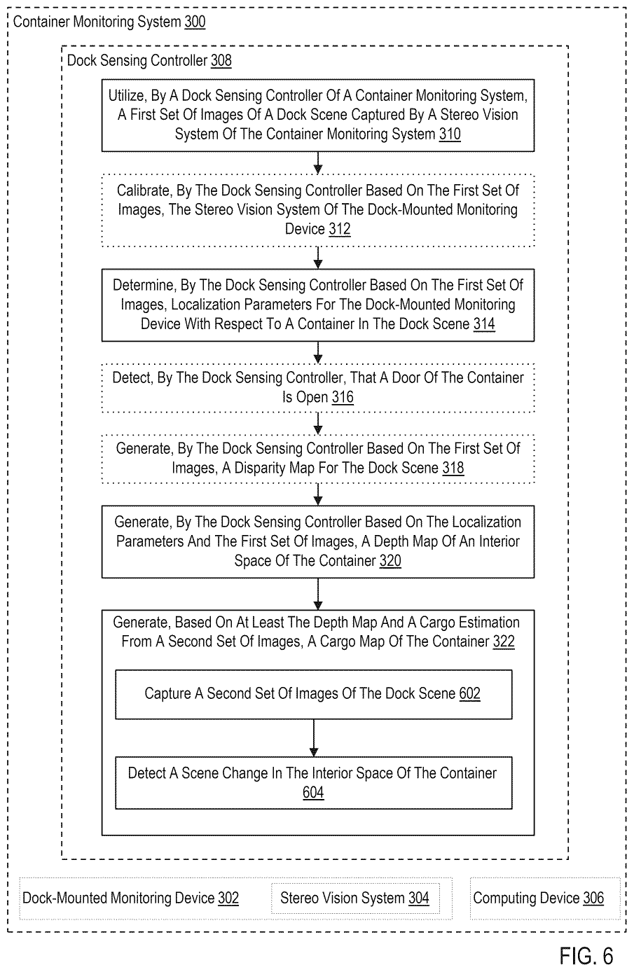

For further explanation, FIG. 6 sets forth another method of volumetric sensing using a container monitoring system in accordance with at least one embodiment of the present disclosure. The method of FIG. 6 extends the method of FIG. 3 in that the method of FIG. 6 in that generating 322, based on at least the depth map and a cargo estimation from a second set of images, a cargo map of the container includes utilizing 602 a second set of images of the dock scene. In some examples, the stereo vision system 304 of the dock-mounted monitoring device captures an updated set of images that includes the interior space of the container. For example, the updated set of images is utilized 602 by the dock sensing controller 308 to determine the occupancy of the container once cargo has been loaded into the container. In some implementations, the dock-mounted monitoring device 302 captures the updated set of images after detecting a loading event. For example, the dock sensing controller 308 may wait until the infrared sensor data indicates that humans or machinery are absent from the interior container space before causing a set of images to be captured for occupancy assessment. The updated set of images may be captured as described above with reference to capturing the first set of images.

In some implementations, any or all of the image preprocessing, stereo calibration, location calibration, and disparity map generation steps described above may be repeated for the updated set of images.

In the method of FIG. 6, generating 322, based on at least the depth map and a cargo estimation from a second set of images, a cargo map of the container further includes detecting 604 a change in the interior space of the container. In some examples, the dock sensing controller 308 detects 604 a change in the interior space of the container by comparing one or more of the updated images to a reference image. For example, the reference image may be one of the images used to generate the depth map of the empty trailer, as described above. In another example, the reference image can be one of the most recently captured images before the current set of images. A comparison of a current image to a reference image may include comparing saturation levels, extracted features, contrast elements, or other characteristics of the images. In some examples, a background subtraction algorithm compares the two images to determine if anything changed between the before and after image. The comparisons may indicate whether the updated set of images includes artifacts that were not present in the previous set of images, which can indicate that cargo has been loaded into the container. In some implementations, the dock sensing controller 308 can determine a change score based at least in part on a previous image. The previous image and the image can be compared to determine whether a difference between the images exceeds a score threshold. In some implementations, a Gaussian blurring is performed on the images to reduce noise associated with sharpening or enhanced contrasts in the images. If the score threshold is exceeded, then the dock sensing controller 308 determines that the scene has changed.

In some examples, if the current scene is the same as the previously measured scene, then the dock sensing controller 308 can report the same data (e.g., occupancy data) to ensure consistency. For example, if there has been no change since the container was determined to be empty, then the dock sensing controller 308 will continue to report that the container is empty. If there has been no change since the container was determined to be 50% full, then the dock sensing controller 308 will continue to report that the container is 50% full. Furthermore, in reusing data associated with the previously measured scene, the dock sensing controller 308 can reduce processing requirements. To make this determination, the dock sensing controller 308 may save the image from camera 1 to the persistent memory as a ‘previous image.’ At the next measurement, the new image from camera 1 and the previous image are compared using a background subtraction algorithm. If very little content changed between the compared images, then the scene is labeled as ‘no change’ and the dock sensing controller 308 can report previously measured data.

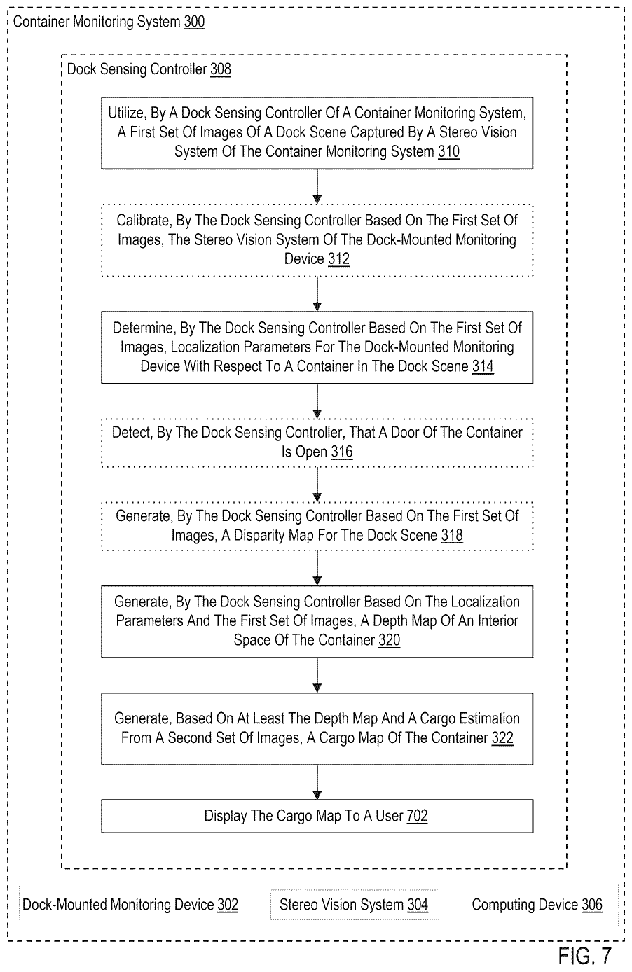

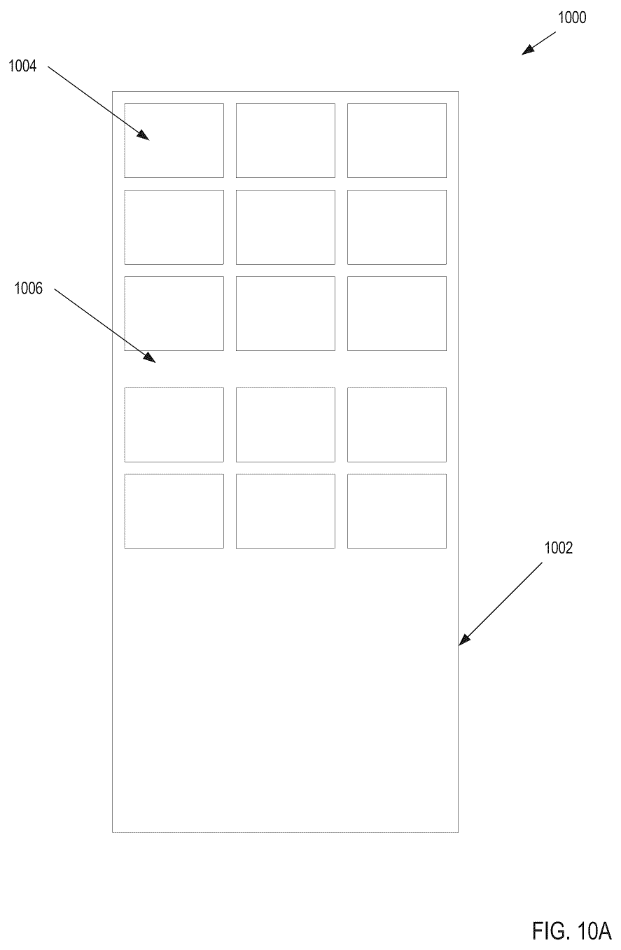

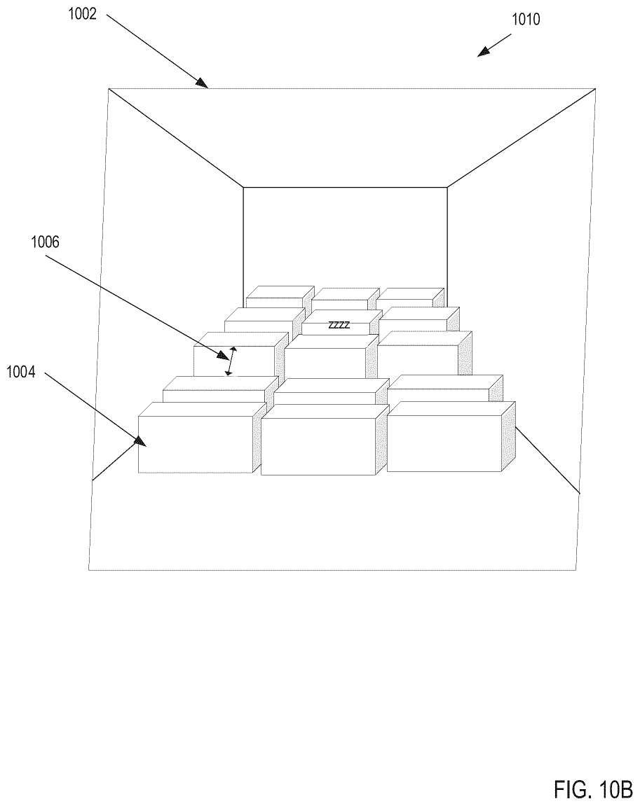

For further explanation, FIG. 7 sets forth another method of volumetric sensing using a container monitoring system in accordance with at least one embodiment of the present disclosure. The method of FIG. 7 extends the method of FIG. 3 in that the method of FIG. 7 further comprises displaying 702 the cargo map to a user. In some implementations, the cargo map is displayed on a computing device 306 that is operated by the user. The computing device 306 can be, for example, a tablet, smart phone, desktop or laptop computer, or another computing device of the container monitoring system. In some examples, the cargo map is rendered in graphics as a three-dimensional representation of the interior space of the container and the cargo items inside the container. In other examples, the cargo map is rendered in graphics as a two-dimensional overhead view of the interior space of the container and the cargo items in the container. For example, the cargo map can display a graphical representation of each cargo item (e.g., a pallet or box) in the cargo container, thus indicating the location of each cargo item, the size of each cargo item, the shape of each cargo item, and so on. An example cargo map is shown in FIGS. 10A and 10B, described in more detail below.

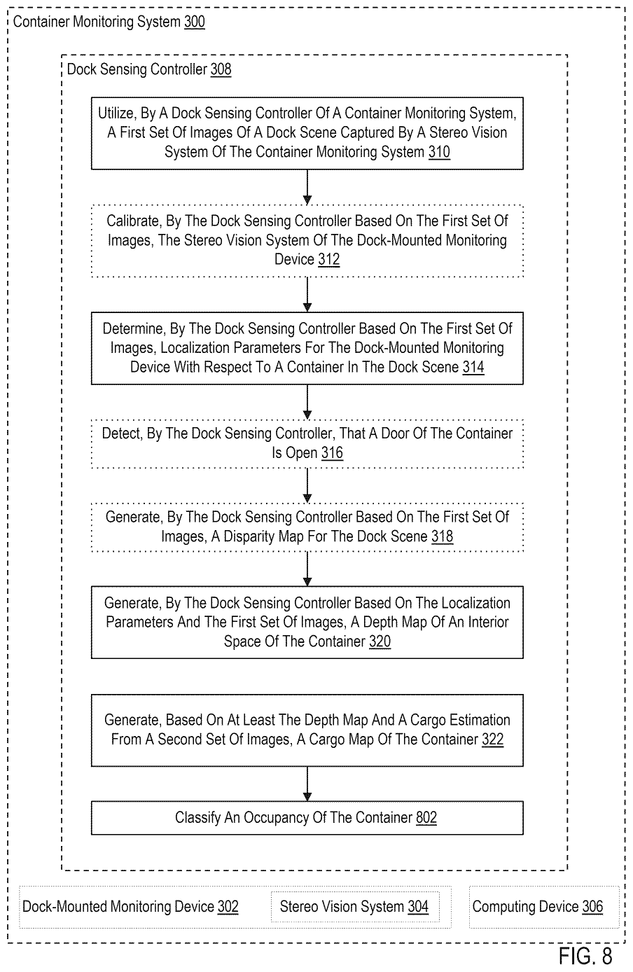

For further explanation, FIG. 8 sets forth another method of volumetric sensing using a container monitoring system in accordance with at least one embodiment of the present disclosure. The method of FIG. 8 extends the method of FIG. 3 in that the method of FIG. 8 further comprises classifying 802 an occupancy of the container. In some examples, the dock sensing controller 308 classifies the occupancy of the container by determining an occupancy score that represents how full the container is. In some examples, occupancy is determined as a difference between a reference volume and a composite volume, where the reference volume is related to the depth map of the empty container and the composite volume is related to the cargo estimate. The volume of the depth map is compared to the volume of the measured cargo depth map to determine scene fullness (i.e., occupancy). The occupancy score may be indicated as a percentage of the reference volume that is occupied by cargo. In some examples, the dock sensing controller 308 classifies occupancy based at least in part on one or more classification algorithms. Examples of classification algorithms include saturation, stereo degradation, scene motion, scene change, corner matching, and so on. In some implementations, localization parameters are used to determine occupancy from the depth map.

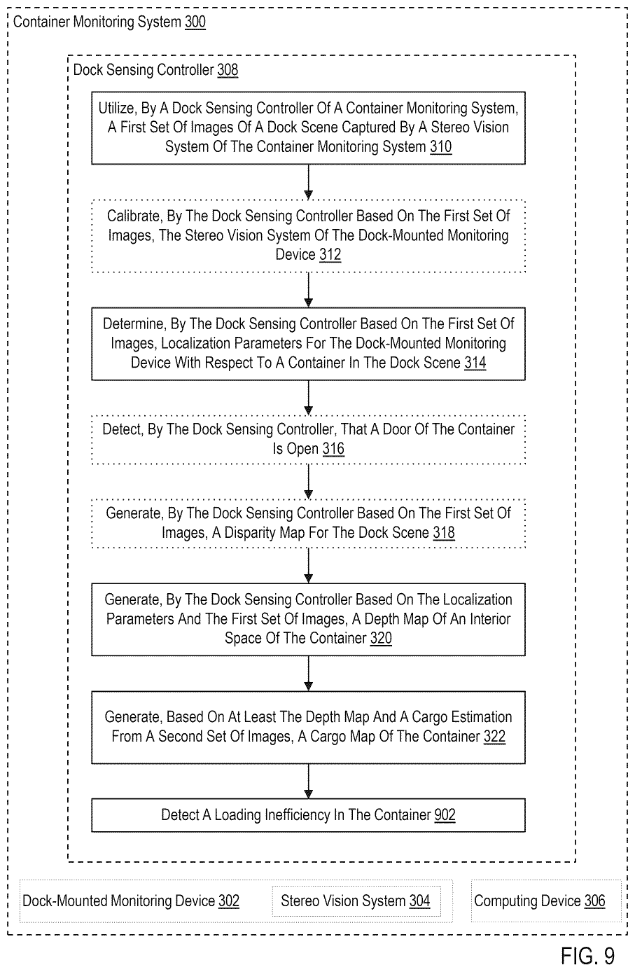

For further explanation, FIG. 9 sets forth another method of volumetric sensing using a container monitoring system in accordance with at least one embodiment of the present disclosure. The method of FIG. 9 extends the method of FIG. 3 in that the method of FIG. 9 further comprises detecting 902 a loading inefficiency in the container. In some examples, the dock sensing controller 308 detects a loading inefficiency in the container based on the cargo map indicating that cargo items (e.g., pallets or crates) are placed in the container in a way that wastes space. For example, cargo items may not be stacked correctly, cargo items may have an improper orientation, cargo items may be spaced too far apart, and so on. In a particular example, the dock sensing controller 308 identifies loading inefficiency by determining a distance between two cargo items and comparing that distance to a maximum distance for efficiently placed cargo items. For example, a distance of 6 inches may be the maximum distance for efficiently placed cargo items, such that two cargo items are not efficiently placed if they are more than 6 inches apart. In such an example, the dock sensing controller 308 detects that the inefficiency in real time. In some examples, the dock sensing controller 308 provides a user alert that indicates the loading inefficiency has been detected to allow dock personnel to cure the inefficiency before additional items are loaded. In some examples, the user alert is made through a mobile device, such as laptop, mobile phone or tablet carried by a dock supervisor. In some examples, the loading inefficiency is graphically represented on a cargo map displayed to a user.

For further explanation, FIGS. 10A and 10B illustrate an example cargo map for volumetric sensing using a container monitoring system in accordance with at least one embodiment of the present disclosure. FIG. 10A illustrates an overhead view cargo map 1000 that shows a representation of various cargo items 1004 (e.g., crates) within the interior space of a container 1002. The map 1000 further illustrates a loading inefficiency 1006 resulting from two rows of cargo items being too far apart. FIG. 10B illustrates a perspective view cargo map 1010 of the cargo map shown in FIG. 10A.

Exemplary embodiments of the present invention are described largely in the context of a fully functional computer system for volumetric sensing using a container monitoring system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will also recognize that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of volumetric sensing using a container monitoring system, the method comprising:
utilizing, by a dock sensing controller of the container monitoring system, a first set of images of a dock scene captured by a stereo vision system of the container monitoring system;
determining based on the first set of images, by the dock sensing controller, localization parameters for a dock-mounted monitoring device with respect to a container in the dock scene;
generating based on the localization parameters and the first set of images, by the dock sensing controller, a depth map of an interior space of the container; and
generating based on the depth map and a cargo estimation from a second set of images, by dock sensing controller, a cargo map of the container.

2. The method of claim 1, wherein the stereo vision system includes at least a first camera and a second camera; and wherein a disparity map includes a pixel offset for each pixel in a first image captured by the first camera relative to a second image captured by the second camera.

3. The method of claim 1, wherein the dock-mounted monitoring device is installed at a fixed position at a dock.

4. The method of claim 3, wherein the container is a trailer parked at the dock.

5. The method of claim 1 further comprising:
capturing, by the dock sensing controller, the first set of images of the dock scene through the stereo vision system.

6. The method of claim 1 further comprising:
detecting, by a trained machine learning classifier of the container monitoring system, that a door of the container is open.

7. The method of claim 1 further comprising:
detecting, based on at least infrared sensor data, a loading event.

8. The method of claim 1, wherein generating based on the depth map and the cargo estimation from a second set of images, by the dock sensing controller, the cargo map of the container includes:
capturing the second set of images of the dock scene; and
detecting a scene change in the interior space of the container.

9. The method of claim 1 further comprising:
classifying an occupancy of the container.

10. The method of claim 1 further comprising:
detecting a loading inefficiency in the container.

11. The method of claim 10, wherein the loading inefficiency is based on a distance between a first cargo item and a second cargo item.

12. The method of claim 1 further comprising:
displaying the cargo map to a user.

13. An apparatus for volumetric sensing using a container monitoring system, the apparatus comprising:
a processor; and
memory storing instructions that, when executed by the processor, cause the apparatus to carry out operations of:
utilizing, by a dock sensing controller of the container monitoring system, a first set of images of a dock scene captured by a stereo vision system of the container monitoring system;
determining based on the first set of images, by the dock sensing controller, localization parameters for a dock-mounted monitoring device with respect to a container in the dock scene;
generating based on the localization parameters and the first set of images, by the dock sensing controller, a depth map of an interior space of the container; and
generating based on the depth map and a cargo estimation from a second set of images, by the dock sensing controller, a cargo map of the container.

14. The apparatus of claim 13, wherein the stereo vision system includes at least a first camera and a second camera; and wherein a disparity map includes a pixel offset for each pixel in a first image captured by the first camera relative to a second image captured by the second camera.

15. The apparatus of claim 13, wherein the dock-mounted monitoring device is installed at a fixed position at a dock.

16. The apparatus of claim 13 further comprising instructions that, when executed by the processor, cause the apparatus to carry out:
detecting, by a trained machine learning classifier of the container monitoring system, that a door of the container is open.

17. The apparatus of claim 13 further comprising instructions that, when executed by the processor, cause the apparatus to carry out:
detecting based on at least infrared sensor data, a loading event.

18. The apparatus of claim 13 further comprising instructions that, when executed by the processor, cause the apparatus to carry out:
displaying, by the dock sensing controller, the cargo map to a user.

19. The apparatus of claim 13 further comprising instructions that, when executed by the processor, cause the apparatus to carry out:
classifying an occupancy of the container.

20. The apparatus of claim 13 further comprising instructions that, when executed by the processor, cause the apparatus to carry out:
detecting a loading inefficiency in the container.
